(19) United States
(12) Patent Application Publication
(10) Pub. No.: US 2024/0323984 A1
(43) Pub. Date: Sep. 26, 2024

(54) METHOD, USER EQUIPMENT AND SYSTEM FOR SIDELINK COMMUNICATION

(71) Applicant: SAMSUNG ELECTRONICS CO., LTD., Suwon-si (KR)

(72) Inventor: Ouming Liu, Suzhou Industrial Park (CN)

(73) Assignee: SAMSUNG ELECTRONICS CO., LTD., Suwon-si (KR)

(21) Appl. No.: 18/594,830

(22) Filed: Mar. 4, 2024

(30) Foreign Application Priority Data
Mar. 24, 2023 (CN) 202310301136.5

(51) Int. Cl. H04W 72/40; H04W 72/543; H04W 72/566

(52) U.S. Cl. CPC H04W 72/40; H04W 72/543; H04W 72/566

(57) ABSTRACT

There is provided a method, a user equipment and a system for sidelink communication. The method for sidelink communication includes: a user equipment (UE) requesting a base station (gNB) to transmit a sidelink resource in response to a sidelink communication request, determining whether an available sidelink resource is received from the gNB, and performing the sidelink communication using a pre-configured sidelink resource for the sidelink communication based on a determination that the available sidelink resource is not received from the gNB and based on a determination that the pre-configured sidelink resource is available.

### CROSS-REFERENCE TO RELATED APPLICATIONS

This application is based on and claims priority under 35 U.S.C. § 119 to Chinese Patent Application No. 202310301136.5, filed on Mar. 24, 2023, in the China National Intellectual Property Administration, the disclosure of which is incorporated by reference herein in its entirety.

### BACKGROUND

### 1. Field

The disclosure relates to a communication field, and more particularly, relates to a method, a user equipment (UE) and a system for sidelink communication.

### 2. Description of Related Art

Sidelink communication is a near field communication technique in which user equipments (UEs) are directly connected to each other through direct connection communication (PC5) interfaces. In addition to providing information exchange in the network coverage range such as new radio (NR) network, the sidelink communication technique can also perform information exchange in a place with no network coverage.

In order to provide a more reliable communication service with lower latency and higher data rate, it is very important to improve the communication performance of the UE in various specific scenarios.

However, if the UE is in an IC (in-coverage) state and the sidelink resource obtained from the base station (gNB) is not available/insufficient or the sidelink resource is not obtained from the gNB, the UE cannot perform sidelink communication normally, thus, security and reliability are decreased.

### SUMMARY

According to an aspect of the disclosure, there is provided a method performed by a user equipment (UE), including: requesting a base station (gNB) to transmit a sidelink resource for a sidelink communication; determining whether an available sidelink resource is received from the gNB; performing the sidelink communication using a pre-configured sidelink resource for the sidelink communication based on a determination that the available sidelink resource is not received from the gNB and based on a determination that the pre-configured sidelink resource is available.

The requesting the gNB to transmit the sidelink resource for the sidelink communication may include: requesting the gNB for RRC connection, and requesting the gNB to transmit the sidelink resource based on a radio resource control (RRC) state of the UE being an idle state or an inactive state and based on system information not including an available sidelink resource; and requesting the gNB to transmit the sidelink resource directly based on the RRC state of the UE being a connected state.

The method may further include determining whether the pre-configured sidelink resource is available after requesting the gNB to transmit the sidelink resource; and starting a timer and waiting to receive the sidelink resource from the gNB based on a determination that the pre-configured sidelink resource is available.

The sidelink communication may be one of a plurality of sidelink communications, each of the plurality of sidelink communications being preset with a corresponding priority, and wherein the starting the timer includes starting the timer based on the priority of the sidelink communication being higher than a reference priority.

The determining whether the available sidelink resource is received from the gNB may include: determining that the available sidelink resource is received from the gNB based on the sidelink resource being received before the timer expires and the sidelink resource being available; and determining that the available sidelink resource is not received from the gNB based on the sidelink resource received before the timer expires being not available or based on the sidelink resource being not received by expiration of the timer.

The available sidelink resource may include TxPoolSelectedNormal information corresponding to the sidelink communication or the available sidelink resource matches a requirement of quality of service (QOS) stream.

The method may include deregistering the UE from a network of the gNB, based on the available sidelink resource being not received from the gNB, and requesting to register the UE to the network again after the sidelink communication is completed.

According to another aspect of the disclosure, there is provided a user equipment (UE) including: a memory storing one or more instructions; and a processor configured to execute the one or more instructions to: request a base station (gNB) to transmit a sidelink resource for a sidelink communication; determine whether an available sidelink resource is received from the gNB; and perform the sidelink communication using a pre-configured sidelink resource for the sidelink communication based on a determination that the available sidelink resource is not received from the gNB and based on a determination that the pre-configured sidelink resource is available.

The processor may be further configured to: request the gNB for RRC connection and request the gNB to transmit the sidelink resource based on a radio resource control (RRC) state of the UE being an idle state or an inactive state and based on system information not including an available sidelink resource; and request the gNB to transmit the sidelink resource directly based on the RRC state of the UE being a connected state.

The processor may be further configured to: determine whether the pre-configured sidelink resource is available after requesting the gNB to transmit the sidelink resource; and start a timer and wait to receive the sidelink resource from the gNB based on a determination that the pre-configured sidelink resource is available.

The sidelink communication may be one of a plurality of sidelink communications, each of the plurality of sidelink communications being preset with a corresponding priority, and wherein the processor may be further configured to start the timer based on the priority of the sidelink communication being higher than a reference priority.

The processor may be further configured to: determine that the available sidelink resource is received from the gNB based on the sidelink resource being received before the timer expires and the sidelink resource being available; and determine that the available sidelink resource is not received from the gNB based on the sidelink resource received before the timer expires being not available, or based on the sidelink resource being not received by expiration of the timer.

The available sidelink resource may include TxPoolSelectedNormal information corresponding to the sidelink communication or the available sidelink resource matches a requirement of quality of service (QOS) stream.

The processor may be further configured to deregister the UE from a network of the gNB, based on the available sidelink resource being not received from the gNB, and request to register the UE to the network again after the sidelink communication is completed.

According to another aspect of the disclosure, there is provided a system including: a user equipment (UE); a base station (gNB), wherein the UE is configured to: request the gNB to transmit a sidelink resource for a sidelink communication; determine whether an available sidelink resource is received from the gNB; perform the sidelink communication using a pre-configured sidelink resource for the sidelink communication based on a determination that the available sidelink resource is not received from the gNB and based on a determination that the pre-configured sidelink resource is available.

According to another aspect of the disclosure, there is provided a system including: a computer-readable medium with computer-executable instructions stored thereon, when being executed, performs a method of including requesting a base station (gNB) to transmit a sidelink resource for a sidelink communication; determining whether an available sidelink resource is received from the gNB; performing the sidelink communication using a pre-configured sidelink resource for the sidelink communication based on a determination that the available sidelink resource is not received from the gNB and based on a determination that the pre-configured sidelink resource is available.

### BRIEF DESCRIPTION OF DRAWINGS

The above and other purposes and features of the disclosure will become clearer, from the following detailed description, taken in conjunction with the accompanying drawings, in which:

FIG. 1 illustrates a method for sidelink communication according to an example embodiment of the disclosure;

FIG. 2 illustrates a method for sidelink communication according to another example embodiment of the disclosure;

FIG. 3 illustrates a diagram of a method for sidelink communication according to an example embodiment of the disclosure;

FIG. 4 illustrates a block diagram of a UE for sidelink communication according to an example embodiment of the disclosure; and

FIG. 5 illustrates a block diagram of a system for sidelink communication according to an example embodiment of the disclosure.

### DETAILED DESCRIPTION

Hereinafter, various example embodiments of the disclosure are described with reference to the drawings, wherein the same reference sign indicates the same or similar component, feature and structure. However, it does not aim at limiting, by the various embodiments stated in the disclosure, the disclosure to specific embodiments, but aims at: The disclosure covers the entire amendments, equivalents and/or substitutes of the disclosure to the extent that they are within the scope of the attached claims and the equivalents thereof. Terms and words used in the following description and claims are not limited to their dictionary meanings, but are only used to enable a clear and consistent understanding of the disclosure. Thus, it is obvious to those skilled in the art: the following descriptions of the various embodiments of the disclosure are only provided for illustrative purpose, rather than limiting the disclosure defined by the attached claims and the equivalents thereof.

It should be understood that the singular includes the plural unless it is clearly indicated in the context additionally. The terms “include” “contain” and “have” used in the disclosure indicate the existence of a disclosed function, operation, or component, but do not exclude other functions, operations, or components.

For example, the expression “A or B” or “at least one of A and/or B” may indicate A and B and A or B. For example, the expression “A or B” or “at least one of A and/or B” may indicate (1) A, (2) B or (3) both A and B.

In the various embodiments of the disclosure, the intention is: when a component (for example, a first component) is called to be in “coupling” or “connection” with another component (for example, a second component), or to be “coupled” or “connected” to another component (for example, a second component), the component may be directly connected to the another component, or may be connected by another component (for example, a third component). In comparison, when a component (for example, a first component) is called to be in “direct coupling” or “direct connection” with another component (for example, a second component), or to be directly coupled or directly connected to another component (for example, a second component), there is no another component (for example, a third component) between the component and the another component.

The expression “be configured to” used in various embodiments when describing the disclosure may be used interchangeably with expressions such as “be applicable to”, “have an ability of . . . ”, “be designed to”, “be suitable for”, “be manufactured to” and “be able to” according to the situation, for example. The term “be configured to” may not indicate to “be specially designed to” according to the hardware for sure. On the contrary, the expression “the device configured to . . . ” in some situations may indicate the device and another device or partially “be able to . . . ”. For example, the expression “a processor configured to perform A, B and C” may indicate the special processor for performing the corresponding operation (for example, an embedded processor) or a common processor for performing the corresponding operation by performing at least one software program stored in the memory device (for example, a central processing unit CPU or an application processor (AP)).

The terms used herein are intended to describe certain embodiments of the disclosure but are not intended to limit the scopes of other embodiments. All the terms (including technical or scientific terms) used in the disclosure may have the same meanings as those normally understood by those skilled in the art, unless it is additionally indicated in the disclosure. Normally, the term defined in the dictionary should be regarded to have the same meaning as the context meaning in the related filed, and should not be understood differently or understood to have an overly formal meaning unless it is clearly defined in the disclosure. In no situation shall the terms defined in the disclosure be intended to be interpreted to exclude embodiments of the disclosure.

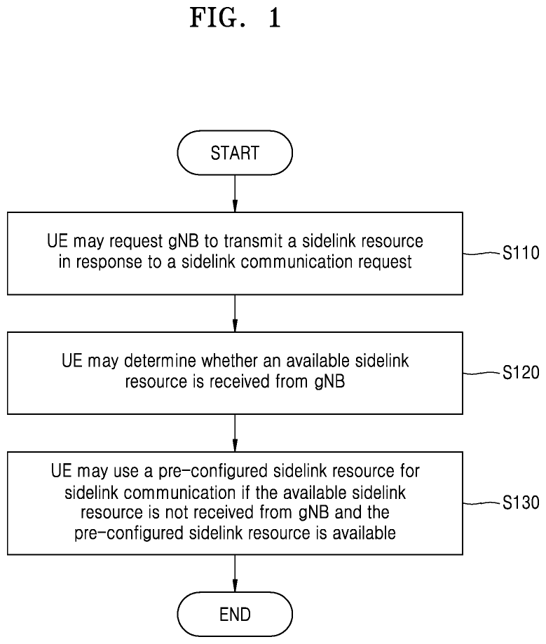

FIG. 1 illustrates a method for sidelink communication according to an example embodiment of the disclosure;

With reference to FIG. 1, in operation S110, a user equipment (UE) may request a base station (gNB) to transmit a sidelink resource for a sidelink communication request. According to an example embodiment, the UE may request the gNB to transmit a sidelink resource based on the sidelink communication request. According to an example embodiment, the UE may request the gNB to transmit a sidelink resource when the UE is in a network coverage of the gNB. According to an example embodiment, the UE may request a base station (gNB) to transmit a sidelink resource in response to a sidelink communication request.

According to an example embodiment, the UE may request the gNB to transmit the sidelink resource based on radio resource control (RRC) state of the UE. That is, the UE may request the gNB to transmit the sidelink resource differently, based on different RRC states of the UE. For example, according to an example embodiment, when the RRC state is an idle (RRC_IDLE) state or inactive (RRC_INACTIVE) state and when system information does not include an available sidelink resource, the UE may request the gNB for RRC connection and request the gNB to transmit the sidelink resource. On the other hand, when the RRC is a connected (RRC_CONNECTED) state, the UE may request the gNB to transmit the sidelink resource directly.

Here, according to an example embodiment, the UE may request the gNB for RRC connection by transmitting RRCSetupRequest message to the gNB and receiving RRCSetup message from the gNB.

In addition, according to an example embodiment, when RRC state is the idle state (RRC_IDLE) or the inactive (RRC_INACTIVE) state, the UE may first obtain the system information from the gNB. Here, the RRC_IDLE, RRC_INACTIVE and RRC_CONNECTED states may all belong to the network in-coverage (IC) state.

In addition, according to an example embodiment, the UE may request the gNB to transmit the sidelink resource through SidelinkUEInformationNR message. For example, the UE may transmit a SidelinkUEInformationNR message to the gNB, and the SidelinkUEInformationNR message may include a request to the gNB to transmit the sidelink resource. Further, the gNB may transmit the sidelink resource through the RRCReconfiguration message, and the sidelink resource may include TxPoolSelectedNormal information, which is normally-transmitted resource pool information.

In operation S120, the UE may determine whether an available sidelink resource is received from the gNB.

According to an example embodiment, the available sidelink resource may include TxPoolSelectedNormal information corresponding to the requested sidelink communication and/or the available sidelink resource may match the requirement of quality of service (QOS) stream.

In operation S130, the UE may use a pre-configured sidelink resource for sidelink communication if the available sidelink resource is not received from the gNB and the pre-configured sidelink resource is available. According to an example embodiment, the UE may determine that the available sidelink resource is not received from the gNB if the sidelink resource obtained from the gNB is not available or insufficient or if the sidelink resource is not obtained from the gNB.

According to an example embodiment, the pre-configured sidelink resource may include data radio bearer (DRB), and/or signaling radio bearer (SRB). However, the disclosure is not limited thereto, and as such, the pre-configured sidelink resource may include other information according to the requirements of the sidelink communication. According to an example embodiment, the pre-configured sidelink resource may be pre-configured by the user in the UE, may be pre-configured by the operator in the UE or may be pre-configured by the manufacturer in the UE manufacturing.

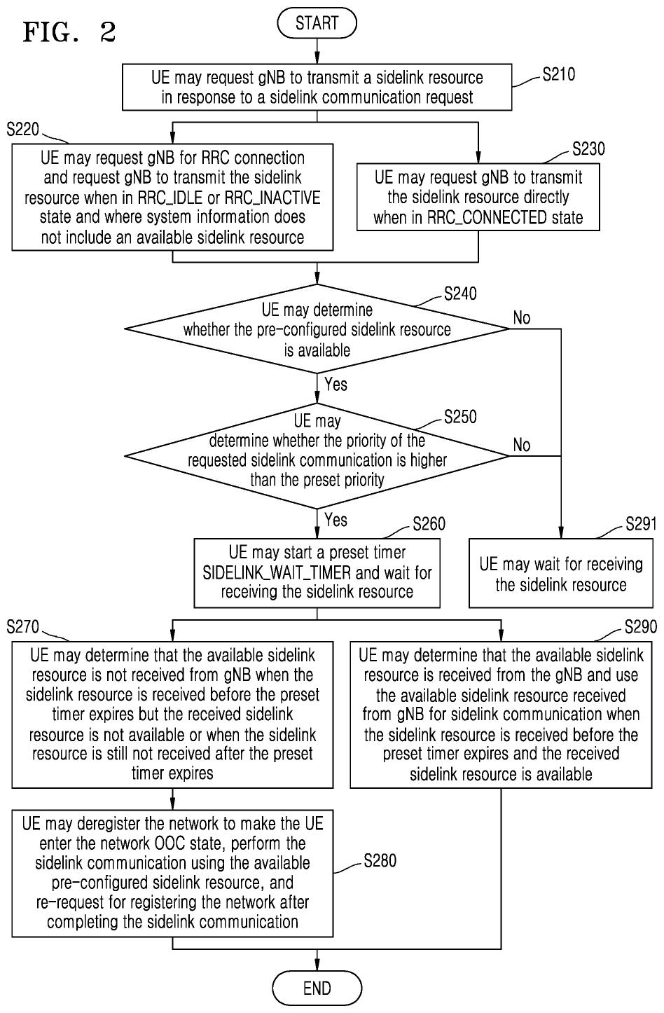

The method for sidelink communication according to an example embodiment of the disclosure illustrated in FIG. 1 will be described more specifically with reference to FIG. 2 below.

FIG. 2 illustrates a method for sidelink communication according to another example embodiment of the disclosure. Here, the operations included in FIG. 1 illustrated in FIG. 2 will not be specifically described.

With reference to FIG. 2, in operation S210, the UE may request the gNB to transmit a sidelink resource in response to a sidelink communication request. For example, the UE may send a message to the gNB, which includes a request the gNB to transmit a sidelink resource when the UE is in a network coverage of the gNB.

In operation S220, the UE may request the gNB for RRC connection and request the gNB to transmit the sidelink resource when the UE is in a RRC IDLE state or a RRC_INACTIVE state and when system information does not include an available sidelink resource. For example, in a case in which the UE is in a RRC_IDLE state or a RRC_INACTIVE state and the system information does not include an available sidelink resource, the UE may request the gNB for RRC connection and request the gNB to transmit the sidelink resource. According to an example embodiment, the system information may be System Information (SI) according to protocols and/or techniques of the new radio (NR) network. For example, system information may be system information block 12 (SIB12).

In operation S230, the UE may request the gNB to transmit the sidelink resource directly in when the UE is in RRC_CONNECTED state. For example, when the RRC state of the UE is RRC_CONNECTED state, the UE may request the gNB to transmit the sidelink resource directly.

In operation S240, the UE may determine whether the pre-configured sidelink resource is available.

According to an example embodiment, in operation S250, if the pre-configured sidelink resource is available, the UE may determine whether the priority of the requested sidelink communication is higher than the preset priority. For example, based on a determination that the pre-configured sidelink resource is available, the UE may determine whether the priority of the requested sidelink communication is higher than the preset priority. Here, according to an example embodiment, different sidelink communications may be preset with corresponding priorities and stored in the UE. That is, different sidelink communications may prioritized in accordance with the requirements of the UE. According to an example embodiment, a priority value ranging from 1-8 may be used to indicate priority. According to an example embodiment, the higher the priority value the lower the priority. However, the disclosure is not limited thereto, and as such, according to another example embodiment, the priority information may be indicated in a different matter. According to an example embodiment, the priority value of 0×FF may indicate invalidity. For example, an indication of invalidity may mean that there is no priority set, the priority information is not valid, or the priority value is not applicable during the UE operation.

According to an example embodiment, if the priority of the requested sidelink communication is higher than the preset priority, in operation S260, the UE may start a preset timer SIDELINK_WAIT_TIMER and wait for receiving the sidelink resource.

According to an example embodiment, a field NV_SIDELINK_PRIORITY may be added into the UE as a preset priority, the NV_SIDELINK_PRIORITY may include the value ranging from 1-8, or 0×FF, which indicates invalidity. According to an example embodiment, NV_SIDELINK_PRIORITY may be set according to needs of the UE operation, and the sidelink communication with a priority higher than the preset priority may respond in a timer manner.

According to an example embodiment, the preset timer may have timing times such as 100 ms, 200 ms, 300 ms, 400 ms, 600 ms, 1000 ms, 1500 ms, 2000 ms and the like, and those skilled in the art may make modifications according to the practical needs without deviating from the disclosure. During the timing of the timer, the UE waits for the gNB to respond to the sidelink resource.

In operation S270, the UE may determine that the available sidelink resource is not received from the gNB when the sidelink resource is not received after the preset timer expires or when the sidelink resource is received before the preset timer expires but the received sidelink resource is not available. Here, the UE may stop the preset timer when the sidelink resource is received or the preset timer expires.

According to an example embodiment, in operation S280, the UE may deregister the network to make the UE enter the network out-of-coverage (OOC) state, perform the sidelink communication using the available pre-configured sidelink resource determined in operation S240, and request to register the UE to the network again after completing the sidelink communication. Here, according to an example embodiment, the UE may request again for registering the UE to the network by transmitting the register requesting message to the gNB and receiving the register accepting message from the gNB.

In addition, in operation S290, when the sidelink resource is received before the preset timer expires and the received sidelink resource is available, the UE may determine that the available sidelink resource is received from the gNB and use the available sidelink resource received from the gNB for sidelink communication. Here, the UE may stop the preset timer when the sidelink resources are received.

According to an example embodiment, the available sidelink resource may include TxPoolSelectedNormal information corresponding to the requested sidelink communication and/or match the requirement of QoS stream. Here, the requirement of QoS stream may be instructed by the RRCReconfiguration message or system information block 12 (SIB12).

In addition, if the pre-configured sidelink resource is not available, or if the priority of the requested sidelink communication is not higher than the preset priority, in operation S291, the UE may wait to receive the sidelink resource. According to an example embodiment, in the case where the pre-configured sidelink resource is not available, the processing method of the UE may be same as a related art method. For example, the UE may wait to receive the sidelink resource directly without subsequent operations. On the other hand, in a case where the priority of the requested sidelink communication is not higher than the preset priority, and the pre-configured sidelink resource is available, the pre-configured sidelink resource may be used for sidelink communication when the available sidelink resource is not received, and the received available sidelink resource may be used for sidelink communication when the available sidelink resource is received. That is, the subsequent processing operations in the case where the priority of the requested sidelink communication is not higher than the preset priority are similar to those of operations S270-S290, and the distinction only lies in removing the operation regarding the preset timer in operations S270-S290. In addition, in the case where the priority of the requested sidelink communication is not higher than the preset priority, the processing method the same as the related art may also be adopted. For example, the UE may wait to receive the sidelink resources directly.

It should be understood that the operations in FIG. 2 that are not included in FIG. 1 are only optional operations of the method for sidelink communication according to an example embodiment of the disclosure illustrated in FIG. 1, which can be added or deleted by those skilled in the art according to needs. For example, operation S250 in FIG. 2 may be an optional operation, the preset timer may be started directly without determining the priority of the requested sidelink communication, which will not be specifically described here.

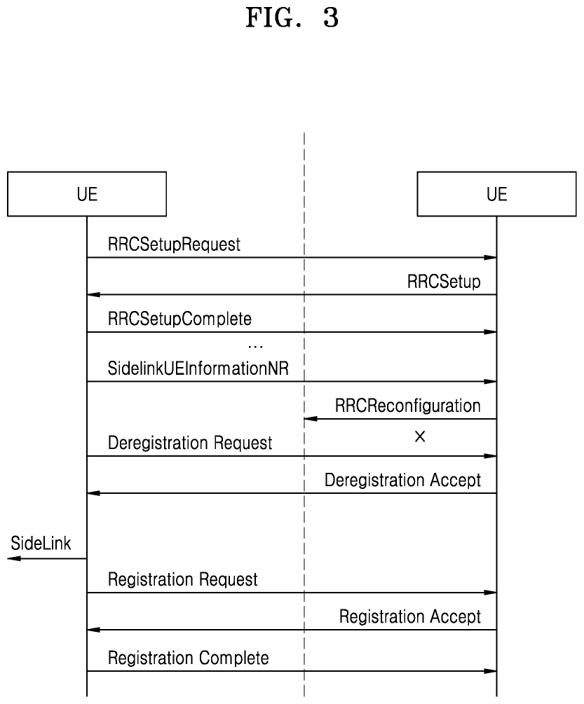

FIG. 3 illustrates a diagram of a method for sidelink communication according to an example embodiment of the disclosure.

As illustrated in FIG. 3, according to the process of FIG. 2, the UE first enters RRC connected state, and then the UE deregisters the network if the available sidelink resource is not received from the gNB, performs the sidelink communication, and request to register the UE to the network again after the sidelink communication is completed.

In addition, the illustrated first three operations in FIG. 3 correspond to the RRC connection operation performed when the UE is in RRC idle state according to an example embodiment. However, the disclosure is not limited thereto, and as such, other manner of RRC connection operation may be performed. For example, as for the RRC connection operation performed when the UE is in an inactive state, it can be performed according to the related art, which will not be illustrated and described in the drawings and the description.

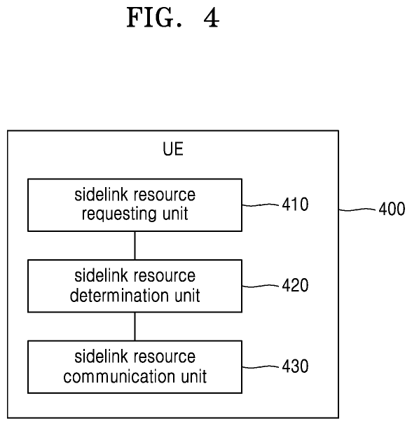

FIG. 4 illustrates a block diagram of a UE for sidelink communication according to an example embodiment of the disclosure.

As illustrated in FIG. 4, the UE 400 for sidelink communication according to an example embodiment of the disclosure may include a sidelink resource requesting unit 410, a sidelink resource determination unit 420 and a sidelink communication performing unit 430. According to an example embodiment, “units” and “modules” may be implemented by hardware, software or a combination of hardware and software. For example, according to an example embodiment, the units may be hardware units implemented by electronic circuits. According to another example embodiment, the units may be software units implemented by program codes or instructions stored in the memory device, which may be executed by a processor to perform one or more operations. According to an example embodiment, the processor may be a special processor for performing the corresponding one or more operations (for example, an embedded processor) or a common processor for performing the corresponding one or more operations by performing at least one software program stored in the memory device (for example, a central processing unit CPU or an application processor (AP)).

The sidelink resource requesting unit 410 may be configured to request the gNB to transmit the sidelink resource in response to a sidelink communication request. According to an example embodiment, when the UE is in a network coverage of the base station gNB, the sidelink resource requesting unit 410 may be configured to request the gNB to transmit the sidelink resource based on the sidelink communication request.

In addition, the sidelink resource requesting unit 410 may be further configured to request the gNB for RRC connection and request the gNB to transmit the sidelink resource when the UE is in a RRC idle state or RRC inactive state and when system information does not include the available sidelink resource. On the other hand, the UE may request the gNB to transmit the sidelink resource directly when the UE is in RRC connected state.

The sidelink resource determination unit 420 may be configured to determine whether the available sidelink resource is received from the gNB. According to an example embodiment, the available sidelink resource includes TxPoolSelectedNormal information corresponding to the requested sidelink communication and/or matches the requirement of QoS stream.

In addition, the sidelink resource requesting unit 420 may be further configured to determine whether the pre-configured sidelink resource is available after requesting the gNB to transmit the sidelink resource; and start a preset timer and wait for receiving the sidelink resource if the pre-configured sidelink resource is available.

In addition, different sidelink communications may be preset with corresponding priorities, and the sidelink resource determination unit 420 may be further configured to start the preset timer in the case where the priority of the requested sidelink communication is higher than the preset priority.

In addition, the sidelink resource requesting unit 420 may be further configured to determine that the available sidelink resource is received from the gNB in the case where the sidelink resource is received before the preset timer expires and the received sidelink resource is available, and determine that the available sidelink resource is not received from the gNB in the case where the sidelink resource is received before the preset timer expires but the received sidelink resource is not available, or the sidelink resource is still not received after the preset timer expires.

The sidelink resource communication unit 430 may be configured to use the pre-configured sidelink resource for sidelink communication if the available sidelink resource is not received from the gNB and the pre-configured sidelink resource is available.

In addition, the UE 400 for sidelink communication according to an example embodiment of the disclosure may further include: a network registering unit configured to deregister the network if the available sidelink resource is not received from the gNB, and request to register the UE to the network again after the sidelink communication is completed.

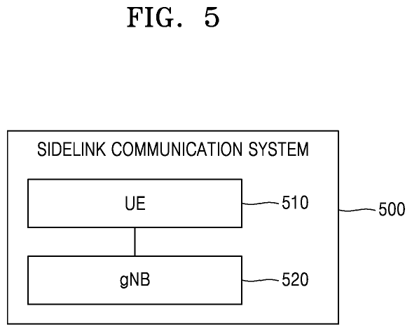

FIG. 5 illustrates a block diagram of a system for sidelink communication according to an example embodiment of the disclosure.

As illustrated in FIG. 5, a system 500 for sidelink communication according to an example embodiment of the disclosure may include a UE 510 and a gNB 520.

The user equipment UE 510 may request the gNB 520 to transmit the sidelink resource in response to a sidelink communication request, in the case of a network coverage of the gNB 520. The UE 510 may determine whether the available sidelink resource is received from the gNB 520. The UE 510 may use the pre-configured sidelink resource for sidelink communication if the available sidelink resource is not received from the gNB 520 and the pre-configured sidelink resource is available.

According to an example embodiment of the disclosure, there is provided an electronic equipment, comprising a storage and a processor, the storage storing computer-executable instructions thereon, wherein, when being executed by the processor, the preceding method is executed.

According to an example embodiment of the disclosure, there is provided a computer-readable medium with computer-executable instructions stored thereon, when being executed, the preceding method is executed.

According to an example embodiment of the disclosure, the pre-configured sidelink resource may be used sufficiently, so that the UE may perform sidelink communication normally in the specific situation, wherein the specific situation includes but is not limited to: the gNB does not transmit the sidelink resource, in the case of a network coverage of the gNB; the UE does not receive the sidelink resource normally; the UE receives the sidelink resource, but the sidelink resource does not include TxPoolSelectedNormal information corresponding to the requested sidelink communication; the UE receives the sidelink resource, but the sidelink resource does not match the requirement of the QoS stream; in addition, by setting the priority for sidelink communication and setting a timer with respect to the sidelink communication with a high priority, the sidelink service with a high priority may be performed in a time-saving and efficient manner using the pre-configured sidelink resource in the above specific situation.

According to an example embodiment of the disclosure, a computer-readable medium storing instructions may also be provided, wherein, when being operated by at least one processor, the instructions promote the at least one processor to execute the method for sidelink communication according to the example embodiment of the disclosure. Examples of the computer-readable storage medium here includes: Read Only Memory (ROM), Programmable Read Only Memory (PROM), Electrically Erasable Programmable Read Only Memory (EEPROM), Random Access Memory (RAM), Dynamic Random Access Memory (DRAM), Static Random Access Memory (STAM), a flash memory, a nonvolatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or CD-ROM memory, Hard Disk Drive (HDD), Solid State Disk (SSD), a card memory (for example, a multimedia card, a Secure Digital (SD) card or a X Digital (XD) card), a magnetic tape, a floppy disk, a magneto-optical data storage device, an optical data storage device, a hard disk and any other devices, and the any other devices are configured to store a computer program and any associated data, data file and data structure in a non-temporary manner, and provide the computer program and any associated data, data file and data structure to the processor or computer, so that the processor or computer can execute the computer program. The computer program in the above computer-readable storage medium may be operated in an environment deployed in a computer apparatus such as a client, host, agent apparatus, server and the like, in addition, in one example, the computer program and any associated data, data file and data structure are distributed on the networked computer system, so that the computer program and any associated data, data file and data structure are stored, accessed and executed by one or more processors or computers in a distribution manner.

While the disclosure has been shown and described with reference to particular example embodiments, it will be understood by those skilled in the art that various changes in form and details may be made without departing from the spirit and scope of the disclosure as defined by the claims and the equivalents thereof.

What is claimed is:

1. A method performed by a user equipment (UE), comprising:
requesting a base station (gNB) to transmit a sidelink resource for a sidelink communication;
determining whether an available sidelink resource is received from the gNB;
performing the sidelink communication using a pre-configured sidelink resource for the sidelink communication based on a determination that the available sidelink resource is not received from the gNB and based on a determination that the pre-configured sidelink resource is available.

2. The method of claim 1, wherein the requesting the gNB to transmit the sidelink resource for the sidelink communication comprises:
requesting the gNB for RRC connection, and requesting the gNB to transmit the sidelink resource based on a radio resource control (RRC) state of the UE being an idle state or an inactive state and based on system information not including an available sidelink resource; and
requesting the gNB to transmit the sidelink resource directly based on the RRC state of the UE being a connected state.

3. The method of claim 1, further comprising:
determining whether the pre-configured sidelink resource is available after requesting the gNB to transmit the sidelink resource; and
starting a timer and waiting to receive the sidelink resource from the gNB based on a determination that the pre-configured sidelink resource is available.

4. The method of claim 3, wherein the sidelink communication is one of a plurality of sidelink communications, each of the plurality of sidelink communications being preset with a corresponding priority, and
wherein the starting the timer comprises starting the timer based on the priority of the sidelink communication being higher than a reference priority.

5. The method of claim 3, wherein the determining whether the available sidelink resource is received from the gNB comprises:
determining that the available sidelink resource is received from the gNB based on the sidelink resource being received before the timer expires and the sidelink resource being available; and
determining that the available sidelink resource is not received from the gNB based on the sidelink resource received before the timer expires being not available or based on the sidelink resource being not received by expiration of the timer.

6. The method of claim 1, wherein the available sidelink resource comprises TxPoolSelectedNormal information corresponding to the sidelink communication or the available sidelink resource matches a requirement of quality of service (QOS) stream.

7. The method of claim 1, further comprising:
deregistering the UE from a network of the gNB, based on the available sidelink resource being not received from the gNB, and requesting to register the UE to the network again after the sidelink communication is completed.

8. A user equipment (UE) comprising:
a memory storing one or more instructions; and
a processor configured to execute the one or more instructions to:
request a base station (gNB) to transmit a sidelink resource for a sidelink communication;
determine whether an available sidelink resource is received from the gNB; and
perform the sidelink communication using a pre-configured sidelink resource for the sidelink communication based on a determination that the available sidelink resource is not received from the gNB and based on a determination that the pre-configured sidelink resource is available.

9. The UE of claim 8, wherein the processor is further configured to:
request the gNB for RRC connection and request the gNB to transmit the sidelink resource based on a radio resource control (RRC) state of the UE being an idle state or an inactive state and based on system information not including an available sidelink resource; and
request the gNB to transmit the sidelink resource directly based on the RRC state of the UE being a connected state.

10. The UE of claim 8, wherein the processor is further configured to:
determine whether the pre-configured sidelink resource is available after requesting the gNB to transmit the sidelink resource; and
start a timer and wait to receive the sidelink resource from the gNB based on a determination that the pre-configured sidelink resource is available.

11. The UE of claim 10, wherein the sidelink communication is one of a plurality of sidelink communications, each of the plurality of sidelink communications being preset with a corresponding priority, and
wherein the processor is further configured to start the timer based on the priority of the sidelink communication being higher than a reference priority.

12. The UE of claim 10, wherein the processor is further configured to:
determine that the available sidelink resource is received from the gNB based on the sidelink resource being received before the timer expires and the sidelink resource being available; and
determine that the available sidelink resource is not received from the gNB based on the sidelink resource received before the timer expires being not available, or based on the sidelink resource being not received by expiration of the timer.

13. The UE of claim 8, wherein the available sidelink resource comprises TxPoolSelectedNormal information corresponding to the sidelink communication or the available sidelink resource matches a requirement of quality of service (QOS) stream.

14. The UE of claim 8, wherein the processor is further configured to deregister the UE from a network of the gNB, based on the available sidelink resource being not received from the gNB, and request to register the UE to the network again after the sidelink communication is completed.

15. A system comprising:
a user equipment (UE);
a base station (gNB),
wherein the UE is configured to:
request the gNB to transmit a sidelink resource for a sidelink communication;
determine whether an available sidelink resource is received from the gNB;
perform the sidelink communication using a pre-configured sidelink resource for the sidelink communication based on a determination that the available sidelink resource is not received from the gNB and based on a determination that the pre-configured sidelink resource is available.

16. A computer-readable medium with computer-executable instructions stored thereon, when being executed, performs the method of claim 1.
